(19) United States
(12) Patent Application Publication
(10) Pub. No.: US 2019/0256429 A1
(43) Pub. Date: Aug. 22, 2019

(54) Silicate Aggregates With Property Spectrums

(71) Applicant: Good Planet Labs, Inc., Las Vegas, NV (US)

(72) Inventor: Robert Michael Hust, Coeur d'Alene, ID (US)

(21) Appl. No.: 16/280,001

(22) Filed: Feb. 19, 2019

Related U.S. Application Data
(60) Provisional application No. 62/632,722, filed on Feb. 20, 2018.

(51) Int. Cl. C04B 41/50; C04B 41/00; C04B 14/24; C04B 18/02; C01B 33/18

(52) U.S. Cl. CPC C04B 41/5024; C04B 41/0072; C01P 2004/45; C04B 18/027; C01B 33/18; C04B 14/24

(57) ABSTRACT

Formation and/or generation of silicate aggregates having a graduated linear spectrum of physical and/or chemical properties are disclosed. For example, a given foamed silicate aggregate may include a graduated linear spectrum of open-cell to closed-cell structures, porous to solid and/or anti-porous structures, and/or both. The foamed silicate aggregate may also include one portion that is heavier than another portion. The aggregate may be constructed of a material that sinks such that the heavier portion contacts a bottom of a body of water, or the aggregate may be constructed of a material that floats such that the heavier portion is below the surface of the water. The aggregate may additionally be stratified and/or may include suspended beads of material.

### RELATED APPLICATIONS

This application claims priority to U.S. Provisional Patent Application No. 62/632,722, filed on Feb. 20, 2018, the entire contents of which are incorporated herein by reference.

### BACKGROUND

The production of glass and/or ceramic aggregates may be beneficial in multiple use cases. Such aggregates have uniform structures and/or properties. Described herein are improvements and technological advances that, among other things, generate silicate aggregates having non-uniform structures and/or properties.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 illustrates a schematic view of a system for generating silicate aggregates with property spectrums.

FIG. 2 is a flowchart illustrating an example process of manufacturing silicate aggregates with property spectrums.

FIG. 3 is a flowchart illustrating another example process of manufacturing silicate aggregates with property spectrums.

FIG. 4 illustrates a cross-sectional view, taken along a center line, of a silicate aggregate with property spectrums.

FIG. 5 illustrates a cross-sectional view, taken along a center line, of another silicate aggregate with property spectrums.

FIG. 6 illustrates a cross-sectional view, taken along a center line, of another silicate aggregate with property spectrums.

FIG. 7 illustrates a perspective view of an example environment containing a body of water, where example silicate aggregates with property spectrums are configured to float on a surface of the body of water.

FIG. 8 illustrates a perspective view of an example environment containing a body of water, where example silicate aggregates with property spectrums are configured to sink to a bottom portion of the body of water.

FIG. 9 illustrates a cross-sectional view of an example stratified silicate aggregate with property spectrums.

FIG. 10 illustrates a top view of example precursor material to which a grid of secondary material has been applied.

FIG. 11 illustrates a schematic view of an example system for generating silicate aggregates having property spectrums and the application of precursor materials to a conveyor element of the system.

### DETAILED DESCRIPTION

Formation and generation of silicate aggregates having non-uniform properties and/or structures are disclosed. Take, for example, situations where silicate aggregates are to be made. Silicate aggregates, otherwise described herein as foam glass and/or ceramic aggregates, may be utilized for a number of purposes, such as insulation, remediation of waste, filler material, a component of concrete or other hardscape, and/or one or more other uses. Generally, silicate aggregates may be composed of a precursor material such as a glass-grade silica powder, ground glass, and/or silica-lime glass, for example. However, conventional silicate aggregates have a single composition, have homogenous and/or uniform properties, have a single density, have a single porosity, and/or are either open-celled or close-celled.

Described herein are novel silicate aggregates that, among other things, may have multiple layers with differing physical properties, may have a graduated linear spectrum of physical and/or chemical properties, may have varying porosities, may have varying densities, and/or may be both close-celled and open-celled at different portions of the silicate aggregates, for example.

For example, the silicate aggregates may include a foamed silicate aggregate and/or a foamed silicate material constructed from a precursor material and a foaming agent. The foamed silicate aggregate may include a graduated linear spectrum of physical characteristics and/or properties. For example, a first side and/or first portion of the foamed silicate aggregate may include an open-cell structure while a second side and/or second portion of the foamed silicate aggregate may include a closed-cell structure. Additionally, a portion of the foamed silicate aggregate between the first side and the second side may exhibit a decreasing degree of the open-celled structure from the first side to the second side such that the foamed silicate aggregate becomes more closed-celled moving from the first side to the second side.

Additionally, or alternatively, the graduated linear spectrum of physical characteristics and/or properties may be associated with porosity. For example, a first side and/or first portion of the foamed silicate aggregate may include a porous structure while a second side and/or second portion of the foamed silicate aggregate may include a solid structure and/or an anti-porous structure. Additionally, a portion of the foamed silicate aggregate between the first side and the second side may exhibit a decreasing degree of porosity from the first side to the second side such that the foamed silicate aggregate becomes denser and less porous moving from the first side to the second side.

Additionally, or alternatively, the graduated linear spectrum may be associated with masses and/or weights of various portions of the foamed silicate aggregate. For example, a first side and/or a first portion of the foamed silicate aggregate may have a first mass and/or a first weight, while a second side and/or a second portion of the foamed silicate aggregate may have a second mass and/or a second weight. In these examples, the second mass may be greater than the first mass. As such, the foamed silicate aggregate may be heavier on one side than on another side. In examples, the precursor material used to form at least a portion of the foamed silicate aggregate may be a material that produces a foamed glass that generally sinks in water and/or other liquid. For example, the material may be Silicon Carbide. In these examples where the foamed silicate aggregate is constructed of a material that sinks in water and where the graduated linear spectrum of physical characteristics includes varying weights of the foamed silicate aggregate, the foamed silicate aggregate may be placed into a body of water and a side (here the second side) that is heavier than another side (here the first side) may orient itself downward toward a bottom of the body of water while the first side may orient itself upward toward a surface of the body of water. These foamed silicate aggregates may be utilized, for example, in waste remediation efforts.

Additionally, or alternatively, a first side and/or a first portion of the foamed silicate aggregate may have a first mass and/or a first weight, while a second side and/or a second portion of the foamed silicate aggregate may have a second mass and/or a second weight. In these examples, the second mass may be greater than the first mass. As such, the foamed silicate aggregate may be heavier on one side than on another side. In examples, the precursor material used to form at least a portion of the foamed silicate aggregate may be a material that easily produces foam glass that floats in water and/or other liquid. For example, the material may be calcium carbide. In these examples where the foamed silicate aggregate is constructed of a material that floats in water and where the graduated linear spectrum of physical characteristics includes varying weights of the foamed silicate aggregate, the foamed silicate aggregate may be placed into a body of water and a side (here the second side) that is heavier than another side (here the first side) may orient itself downward such that the second side is oriented below a surface of the body of water while the first side is oriented above the surface of the body of water. These foamed silicate aggregates may be utilized, for example, in waste remediation efforts.

Additionally, or alternatively, the foamed silicate aggregates may be stratified into two or more layers. In these examples, some or all of the layers may be associated with physical and/or chemical properties that differ from one or more other layers of the foamed silicate aggregate. For example, the layers may be constructed of different precursor materials with different chemical compositions, the layers may have differing porosities, the layers may have differing densities, some of the layers may be open-celled while other layers may be closed-celled and/or the degree of open-celled structure may differ as between layers, and/or the masses and/or weights of the layers may differ. It should be understood that while the foamed silicate aggregates may be described as stratified, the layers may not be completely separate in some examples. Instead, the junction and/or interface between layers may include an area where the layers are bonded, at least partially, together. These junctions and/or interfaces may include characteristics that are the same as or differ from one or more of the layers themselves.

Additionally, or alternatively, the graduated linear spectrum may be associated with chemical properties of the foamed silicate aggregates. For example, a first side and/or first portion of the foamed silicate aggregate may have first chemical properties while a second side and/or second portion of the foamed silicate aggregate may have second chemical properties. In these examples, a portion of the foamed silicate aggregate between the first side and the second side may exhibit third chemical properties representing a decreasing degree of the first chemical properties and an increasing degree of the second chemical properties from the first side to the second side.

Additionally, or alternatively, instead of applying two or more layers of precursor materials to a conveyor element and heating the materials with a kiln. One or more layers of precursor materials may be applied to the conveyor element and an injection element may inject a secondary material having one or more differing properties from the layer(s) of precursor materials on top of the layer(s) of precursor materials. In examples, the injection element may apply the secondary material in a grid pattern. When heated by the kiln, the injected secondary material may disperse partially over the top of the other precursor materials. In these examples, the side of the foamed silicate aggregate corresponding to the secondary precursor material may have a first surface area that is less than a second surface area corresponding to the layer(s) of precursor materials. In examples, the injected secondary material may include at least one of ceramic, clay, and/or zeolite.

Systems to generate the silicate aggregates described herein may include, for example, a conveyor element such as a conveyor belt configured to move precursor materials into a kiln and move produced silicate aggregate from the kiln to a holding container. The system may also include, two or more hoppers that may be configured to hold precursor materials. The hoppers may be positioned at a point before the kiln such that as materials exit the hoppers and land on the conveyor element, the conveyor element may convey the materials into the kiln. The hoppers may be substantially adjacent to each other and may each have an opening on an end of the hoppers proximal to the conveyor element. The opening may allow the precursor materials to flow from the hoppers onto the conveyor element. The opening may be adjustable such that more or less precursor material is allowed to flow from the hoppers to the conveyor element. The systems may additionally include one or more kilns. The kiln may be configured to allow a portion of the conveyor element to pass through at least a portion of the kiln such that the precursor materials may enter an interior portion of the kiln, and silicate aggregate product may exit the kiln. For example, the kiln may have a channel configured to receive a portion of the conveyor element, with a first end of the kiln configured to receive the precursor materials via the conveyor element and a second end of the kiln, opposite the first end, configured to output a product from the kiln. The kiln may be configured to apply heat to the precursor material as it travels through the kiln. In examples, the amount of heat applied by the kiln to the precursor materials may be adjustable. For example, the temperature inside the kiln may be set to between about 900° Fahrenheit and about 1,600° Fahrenheit. In further examples, the kiln may be configured to apply a heating gradient and/or differing temperatures to the precursor materials as they travel through the kiln. For example, a temperature of the kiln may be adjusted to be the highest about ⅓ of the way through the kiln such that the precursor materials may reach a working point and/or working temperature. Thereafter, the temperature may vary depending on, for example, the speed at which the conveyor element is moving and/or specifications for the silicate aggregate product desired as output from the kiln. In examples, the time between when the precursor materials enter the kiln and when a silicate aggregate product exits the kiln may be between about 40 minutes and about 75 minutes.

The systems may also include one or more computing components that may be utilized to control the operation of the various components of the systems. For example, the computing components may include one or more processors, one or more network interfaces, and/or memory storing instructions that, when executed, cause the one or more processors to perform operations associated with the manufacture of silicate aggregates. For example, the operations may include controlling the speed at which the conveyor element moves, the volume of precursor material that exits one or more of the hoppers, a time at which the hoppers are moved by the derricks for filling of precursor materials and/or for placement above the conveyor element, an amount of precursor material added to the hoppers, a time at which the hoppers start and/or stop allowing precursor materials to travel from the hoppers to the conveyor element, a temperature and/or temperature gradient at which to set the kiln, and/or when to enable and/or disable one or more components of the systems. The computing components may include one or more input mechanisms such as a keyboard, mouse, touchscreen, etc. to allow a user of the system to physically provide input to the computing components to control the silicate aggregate manufacturing systems.

Additionally, or alternatively, the hoppers of the systems may be configured to release precursor materials in one of various ways. For example, in a first instance where a given system includes two hoppers, the two hoppers may be configured to release precursor materials at substantially the same time such that a first hopper transfers a first layer of precursor material onto the conveyor element. A second hopper positioned between the first hopper and the kiln may be configured to transfer a second layer of the precursor material or another precursor material onto the conveyor element. While two hoppers are described in this example as transferring two layers of precursor materials, it should be understood that the system may have two or more than two hoppers, and those hoppers may transfer two or more than two layers of precursor materials. In these examples, the thickness of each of the several layers may be controllable, such as by controlling the amount of precursor material exiting a given hopper per unit time.

The systems described herein may be utilized to generate the foamed silicate aggregates also described herein. For example, a process for generating the foamed silicate aggregates may include mixing, in a first vessel, a first precursor material with a first amount of a first foaming agent, and mixing, in a second vessel, at least one of the first precursor material or a second precursor material with a second amount of at least one of the first foaming agent or a second foaming agent. In these examples, the same precursor material may be utilized for each of the two precursor mixtures or differing precursor materials may be utilized. Additionally, the same foaming agent may be utilized for each of the two precursor mixtures or differing foaming agents may be utilized. In examples, the amount of foaming agent utilized as between the precursor mixtures may be the same or may differ.

The process may also include loading the first mixture into a first hopper positioned above the conveyor element and loading the second mixture into a second hopper positioned above the conveyor and between the first hopper and the kiln. The first hopper may be caused to release the first mixture onto the conveyor element such that a first layer of material is formed on the conveyor element. The second hopper may also be caused to release the second mixture onto the first layer such that a second layer of precursor materials is formed on the first layer of materials. It should be understood that while the two layers may be deposited and may maintain separation, in examples, a degree of mixing at the interface between the two layers may occur. Additionally, it should be understood that while two layers of material are utilized herein by way of example, the process may include utilizing two layers or more than two layers of precursor materials.

The process may also include causing the conveyor element to convey the first layer and the second layer into the kiln such that heat is applied to the first layer and the second layer.

By so doing, the foamed silicate aggregate may be formed and may exhibit a graduated linear spectrum of physical and/or chemical properties from a first side of the foamed silicate aggregate to a second side of the foamed silicate aggregate. The product exiting the kiln may be compacted and/or fractured (either naturally or by applying force). The fractured product may be collected and may be utilized for one or more purposes as described herein.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details of these and other examples are described below with reference to the drawings.

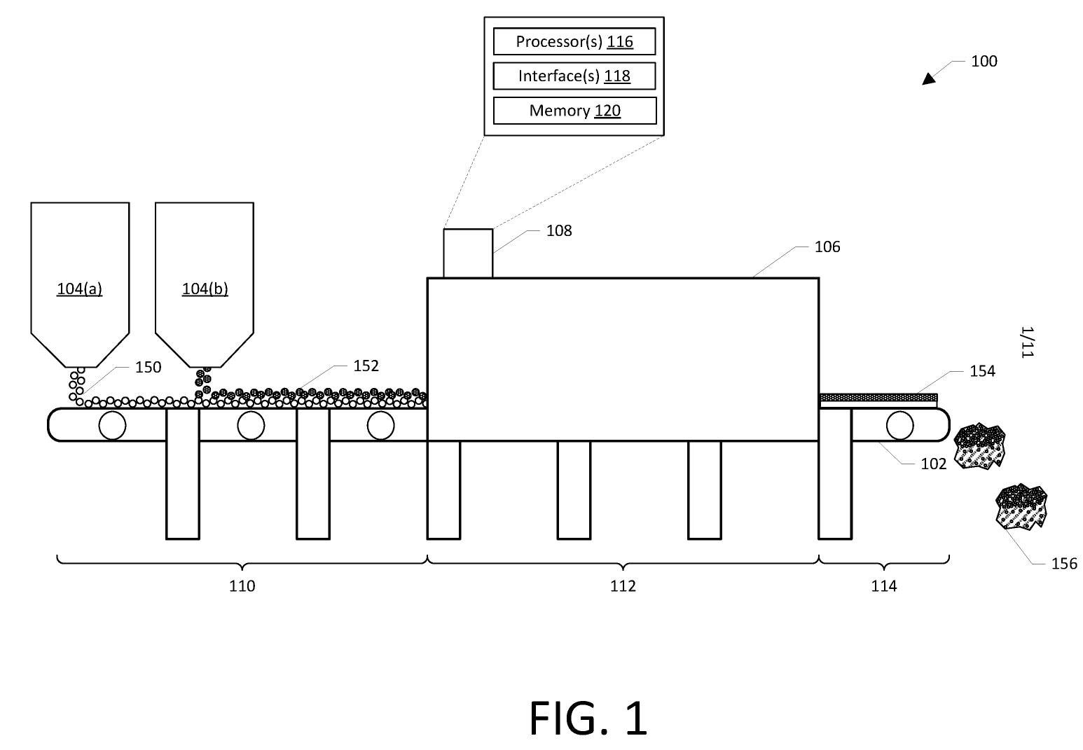

FIG. 1 depicts a side view of an example system 100 for generating silicate aggregates with property spectrums. The system 100 may include, for example, a conveyor element 102, two or more hoppers 104(a)-(b), a kiln 106, and computing components 108. Each of these components will be described below by way of example.

The conveyor element 102, which may be a conveyor belt, may be configured to move precursor materials 150, 152 into the kiln 106 and move produced silicate aggregate 154 from the kiln 106 to a holding container (not depicted). The conveyor element 102 may be configured to vary the speed at which the conveyor element 102 moves precursor materials 150, 152. For example, the speed of movement of the conveyor element 102 may be adjustable such that an amount of time from when the precursor material 150, 152 enter the kiln 106 and when the produced silicate aggregates 154 exit the kiln 106 may be varied. In examples, the amount of time may be between about 40 minutes and about 75 minutes. Additionally, the conveyor element 102 may include a first section 110, a second section 112, and a third section 114. In examples, the first section 110 may include at least the portion of the conveyor element 102 that is positioned below the two or more hoppers 104(a)-(b). The second section 112 may include at least the portion of the conveyor element 102 that is associated with and/or is held within the kiln 106. The third section 114 may include at least the portion of the conveyor element 102 after the kiln 106 and that carries, when in use, produced silicate aggregate 154 from the kiln 106.

The two or more hoppers 104(a)-(b) may be configured to hold precursor materials 150, 152. The hoppers 104(a)-(b) may be positioned at a point before the kiln 106, such that as materials 150, 152 exit the hoppers 104(a)-(b) and are transferred to the conveyor element 102, the conveyor element 102 may convey the materials 150, 152 into the kiln 106. The hoppers 104(a)-(b) may be substantially adjacent to each other and each hopper 104(a)-(b) may have an opening on an end of the hoppers 104(a)-(b) proximal to the conveyor element 102. The opening may allow the precursor materials 150, 152 to flow from the hoppers 104(a)-(b) onto the conveyor element 102. The opening may be adjustable such that more or less precursor material 150, 152 is allowed to flow from the hoppers 104(a)-(b) to the conveyor element 102. The hoppers 104(a)-(b) may also include a wheel, roller, and/or drum housed within the hoppers and configured to rotate to promote the flow of precursor material 150, 152 within the hoppers 104(a)-(b) and through the opening. The wheel, roller, and/or drum may be configured to turn at various, adjustable speeds to increase or decrease the flow of precursor material 150, 152 from the hoppers 104(a)-(b) to the conveyor element 102.

It should be understood that while two hoppers 104(a)-(b) are depicted with respect to FIG. 1, the system 100 may include two, three, or more than three hoppers. Additionally, while one or more examples described herein discuss the hoppers generally holding precursor material, it should be understood that the hoppers may all hold the same precursor material or one or more of the hoppers may hold a precursor material that differs in one or more respects from precursor material held by another of the hoppers. For example, a precursor material may include a glass-grade silica powder, ground glass, and/or silica-lime glass, for example. The precursor materials may also include one or more foaming agents, such as calcium-carbonate lime. The types of precursor materials and/or the quantities of precursor materials, both within a given hopper and/or as between hoppers, may vary from hopper to hopper.

Additionally, one or more derricks and/or similar mechanisms may be attached, either fixedly or removeably, to the hoppers 104(a)-(b) and may be configured to move the hoppers 104(a)-(b) from a position above the conveyor element 102 to a position that allows for filling of the hoppers 104(a)-(b) with precursor materials 150, 152. In examples, each hopper 104(a)-(b) is associated with its own derrick 106(a)-(b). For example, a first hopper 104(a) may be associated with a first derrick and a second hopper 104(b) may be associated with a second derrick. In other examples, single derrick may be utilized to manipulate the hoppers 104(a)-(b), and in these examples, the derrick may have a grasping element configured to grasp a given hopper 104(a)-(b). In still other examples, the hoppers 104(a)-(b) may stationary and no derrick may be utilized. As used herein, a derrick may describe a type of crane with a movable pivoted arm for moving and/or lifting heavy objects, such as hoppers 104(a)-(b). It should be understood that the derricks may also be described as a hoist, lift, lifting machining, moving machine, and/or rig.

The kiln 106 may be configured to allow a portion of the conveyor element 102 to pass through at least a portion of the kiln 106 such that the precursor materials 150, 152 may enter an interior portion of the kiln 106, and silicate aggregate product 154 may exit the kiln 106. For example, the kiln 106 may have a channel configured to receive a portion of the conveyor element, with a first end of the kiln 106 configured to receive the precursor materials 150, 152 via the conveyor element 102 and a second end of the kiln 106, opposite the first end, configured to output a product 154 from the kiln 106. In examples, the kiln 106 may be positioned relative to the second section 112 of the conveyor element 102. The kiln 106 may be configured to apply heat to the precursor material 150, 152 as it travels through the kiln 106. In examples, the amount of heat applied by the kiln 106 to the precursor materials 150, 152 may be adjustable. For example, the temperature inside the kiln 106 may be between about 900° Fahrenheit and about 1,600° Fahrenheit. In further examples, the kiln 106 may be configured to apply a heating gradient and/or differing temperatures to the precursor materials 150, 152 as they travel through the kiln 106. For example, a temperature of the kiln 106 may be adjusted to be the highest about ⅓ of the way through the kiln 106 such that the precursor materials 150, 152 may reach a working point and/or working temperature at that point in the kiln 106. Thereafter, the temperature may vary depending on, for example, the speed at which the conveyor element 102 is moving and/or specifications for the silicate aggregate product 154 desired as output from the kiln 106. In examples, the time between when the precursor materials 150, 152 enter the kiln 106 and when a silicate aggregate product 154 exits the kiln 106 may be between about 40 minutes and about 75 minutes.

Additionally, the produced silicate aggregate 154 may be fractured and/or compacted to form the foamed silicate aggregate articles of manufacture 156. The articles of manufacture 156 may be collected and/or stored and utilized for the one or more purposes described herein and/or other purposes. The foamed silicate aggregates 156 may exhibit a graduate linear spectrum of physical and/or chemical properties. For example, a first side and/or first portion of the foamed silicate aggregate 156 may include an open-cell structure while a second side and/or second portion of the foamed silicate aggregate 156 may include a closed-cell structure. Additionally, a portion of the foamed silicate aggregate 156 between the first side and the second side may exhibit a decreasing degree of the open-celled structure from the first side to the second side such that the foamed silicate aggregate 156 becomes more closed-celled moving from the first side to the second side.

Additionally, or alternatively, the graduated linear spectrum of physical characteristics and/or properties may be associated with porosity. For example, a first side and/or first portion of the foamed silicate aggregate 156 may include a porous structure while a second side and/or second portion of the foamed silicate aggregate 156 may include a solid structure and/or an anti-porous structure. Additionally, a portion of the foamed silicate aggregate 156 between the first side and the second side may exhibit a decreasing degree of porosity from the first side to the second side such that the foamed silicate aggregate 156 becomes denser and less porous moving from the first side to the second side.

Additionally, or alternatively, the graduated linear spectrum may be associated with masses and/or weights of various portions of the foamed silicate aggregate 156. For example, a first side and/or a first portion of the foamed silicate aggregate 156 may have a first mass and/or a first weight, while a second side and/or a second portion of the foamed silicate aggregate 156 may have a second mass and/or a second weight. In these examples, the second mass may be greater than the first mass. As such, the foamed silicate aggregate 156 may be heavier on one side than on another side. In examples, the precursor material used to form at least a portion of the foamed silicate aggregate 156 may be a material that sinks in water and/or other liquid. For example, the material may be ______. In these examples where the foamed silicate aggregate 156 is constructed of a material that sinks in water and where the graduated linear spectrum of physical characteristics includes varying weights of the foamed silicate aggregate, the foamed silicate aggregate 156 may be placed into a body of water and a side (here the second side) that is heavier than another side (here the first side) may orient itself downward toward a bottom of the body of water while the first side may orient itself upward toward a surface of the body of water. These foamed silicate aggregates 156 may be utilized, for example, in waste remediation efforts.

Additionally, or alternatively, a first side and/or a first portion of the foamed silicate aggregate 156 may have a first mass and/or a first weight, while a second side and/or a second portion of the foamed silicate aggregate 156 may have a second mass and/or a second weight. In these examples, the second mass may be greater than the first mass. As such, the foamed silicate aggregate 156 may be heavier on one side than on another side. In examples, the precursor material used to form at least a portion of the foamed silicate aggregate 156 may be a material that floats in water and/or other liquid. For example, the material may be ______. In these examples where the foamed silicate aggregate 156 is constructed of a material that floats in water and where the graduated linear spectrum of physical characteristics includes varying weights of the foamed silicate aggregate 156, the foamed silicate aggregate 156 may be placed into a body of water and a side (here the second side) that is heavier than another side (here the first side) may orient itself downward such that the second side is oriented below a surface of the body of water while the first side is oriented above the surface of the body of water. These foamed silicate aggregates 156 may be utilized, for example, in waste remediation efforts.

Additionally, or alternatively, the foamed silicate aggregates 156 may be stratified into two or more layers. In these examples, some or all of the layers may be associated with physical and/or chemical properties that differ from one or more other layers of the foamed silicate aggregate 156. For example, the layers may be constructed of different precursor materials with different chemical compositions, the layers may have differing porosities, the layers may have differing densities, some of the layers may be open-celled while other layers may be closed-celled and/or the degree of open-celled structure may differ as between layers, and/or the masses and/or weights of the layers may differ. It should be understood that while the foamed silicate aggregates 156 may be described as stratified, the layers may not be completely separate in some examples. Instead, the junction and/or interface between layers may include an area where the layers are bonded, at least partially, together. These junctions and/or interfaces may include characteristics that are the same as or differ from one or more of the layers themselves.

Additionally, or alternatively, the graduated linear spectrum may be associated with chemical properties of the foamed silicate aggregates 156. For example, a first side and/or first portion of the foamed silicate aggregate 156 may have first chemical properties while a second side and/or second portion of the foamed silicate aggregate 156 may have second chemical properties. In these examples, a portion of the foamed silicate aggregate 156 between the first side and the second side may exhibit third chemical properties representing a decreasing degree of the first chemical properties and an increasing degree of the second chemical properties from the first side to the second side.

Additionally, or alternatively, instead of applying two or more layers of precursor materials 150, 152 to a conveyor element 102 and heating the materials with a kiln 106. One or more layers of precursor materials 150, 152 may be applied to the conveyor element 102 and an injection element may inject a seocndary material having one or more differing properties from the layer(s) of precursor materials 150, 152 on top of the layer(s) of precursor materials 150, 152. In examples, the injection element may apply the secondary material in a grid pattern. When heated by the kiln 106, the injected secondary material may disperse partially over the top of the other precursor materials 150, 152. In these examples, the side of the foamed silicate aggregate 156 corresponding to the injected secondary material may have a first surface area that is less than a second surface area corresponding to the layer(s) of precursor materials 150, 152. In examples, the injected secondary material may include at least one of ceramic, clay, and/or zeolite.

In examples, one or more mechanical and/or tactile means of controlling the components of the system 100 and/or measuring certain precursor materials and/or products may be utilized. For example, one or more buttons, switches, levers, wheels, shutters, and/or other mechanical mechanisms may be utilized to control the speed at which the conveyor element 102 moves, the volume of precursor material that exits one or more of the hoppers 104(a)-(b), a time at which the hoppers 104(a)-(b) are moved by the derricks for filling of precursor materials and/or for placement above the conveyor element 102, an amount of precursor material added to the hoppers 104(a)-(b), a time at which the hoppers 104(a)-(b) start and/or stop allowing precursor materials to travel from the hoppers 104(a)-(b) to the conveyor element 102, a temperature and/or temperature gradient at which to set the kiln 106, and/or when to enable and/or disable one or more components of the system 100.

The one or more computing components 108 may be utilized to control the operation of the various components of the system 100. For example, the computing components 108 may include one or more processors 116, one or more network interfaces 118, and/or memory 120 storing instructions that, when executed, cause the one or more processors 116 to perform operations associated with the manufacture of silicate aggregates. For example, the operations may include controlling the speed at which the conveyor element 102 moves, the volume of precursor material 150, 152 that exits one or more of the hoppers 104(a)-(b), a time at which the hoppers 104(a)-(b) are moved by the derricks for filling of precursor materials 150, 152 and/or for placement above the conveyor element 102, an amount of precursor material 150, 152 added to the hoppers 104(a)-(b), a time at which the hoppers 104(a)-(b) start and/or stop allowing precursor materials 150, 152 to travel from the hoppers 104(a)-(b) to the conveyor element 102, a temperature and/or temperature gradient at which to set the kiln 106, and/or when to enable and/or disable one or more components of the system 100. The computing components 108 may include one or more input mechanisms such as a keyboard, mouse, touchscreen, etc. to allow a user of the system to physically provide input to the computing components 108 to control the silicate aggregate manufacturing systems.

Additionally, or alternatively, the one or more network interfaces 118 may be configured to receive data from one or more other devices, such as mobile devices and/or remote servers and/or remote systems. In these examples, the received data may cause the system 100 to perform one or more of the operations described above such that a user need not be physically present at the system 100 to operate it. Additionally, the network interfaces 118 may be utilized to send data associated with the operations of the system 100 to the one or more other devices. By so doing, one or more remote operators and/or users may be enabled to observe operation of the system 100 without necessarily being physically present at the system 100. In these examples, the system 100 may include one or more sensors that may generate data indicating operational parameters of the system 100. For example, one or more temperature sensors, pressure sensors, motion sensors, and/or weight and/or volume sensors may be included in the system.

As used herein, a processor, such as processor 116, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 116 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 118 may possess its own local memory, which also may store program components, program data, and/or one or more operating systems.

The memory 120 may include volatile and nonvolatile memory, removable and non-removable media implemented in any method or technology for storage of information, such as computer-readable instructions, data structures, program component, or other data. Such memory 120 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 120 may be implemented as computer-readable storage media (“CRSM”), which may be any available physical media accessible by the processor(s) 116 to execute instructions stored on the memory 120. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 120, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon. com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 118 may enable messages between the components and/or devices shown in system 100 and/or with one or more other remote systems, as well as other networked devices. Such network interface(s) 118 may include one or more network interface controllers (NICs) or other types of transceiver devices to send and receive messages over a network.

For instance, each of the network interface(s) 118 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 120 may include a wide area network (WAN) component to enable message over a wide area network.

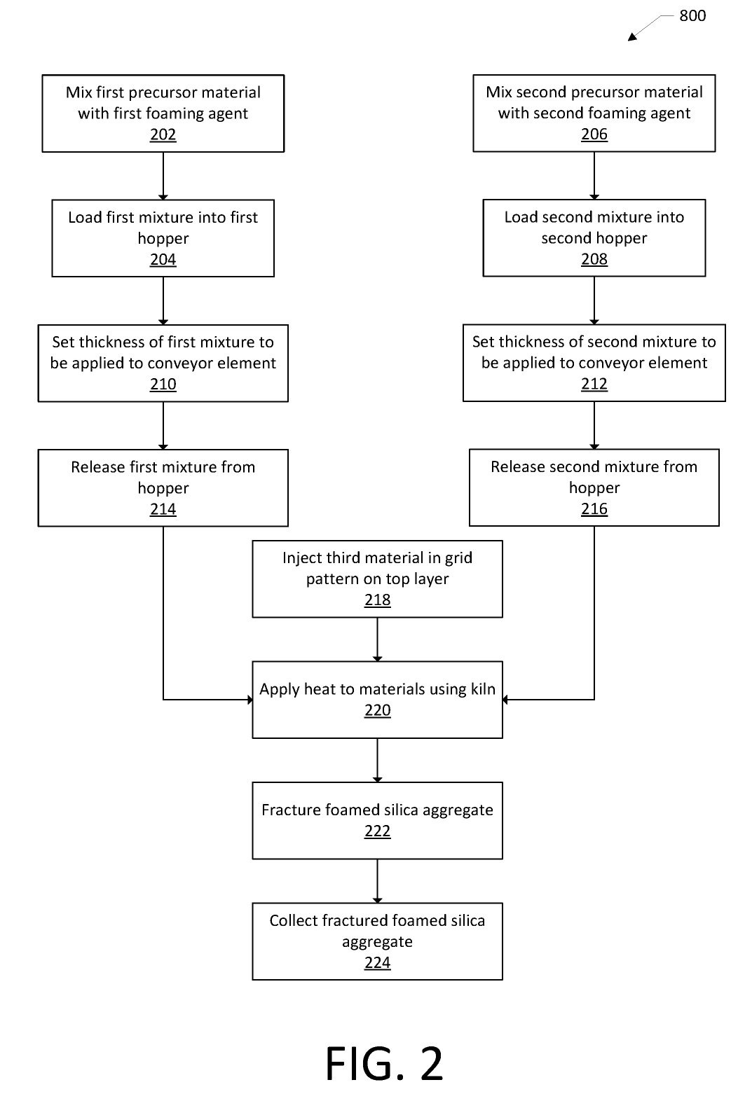

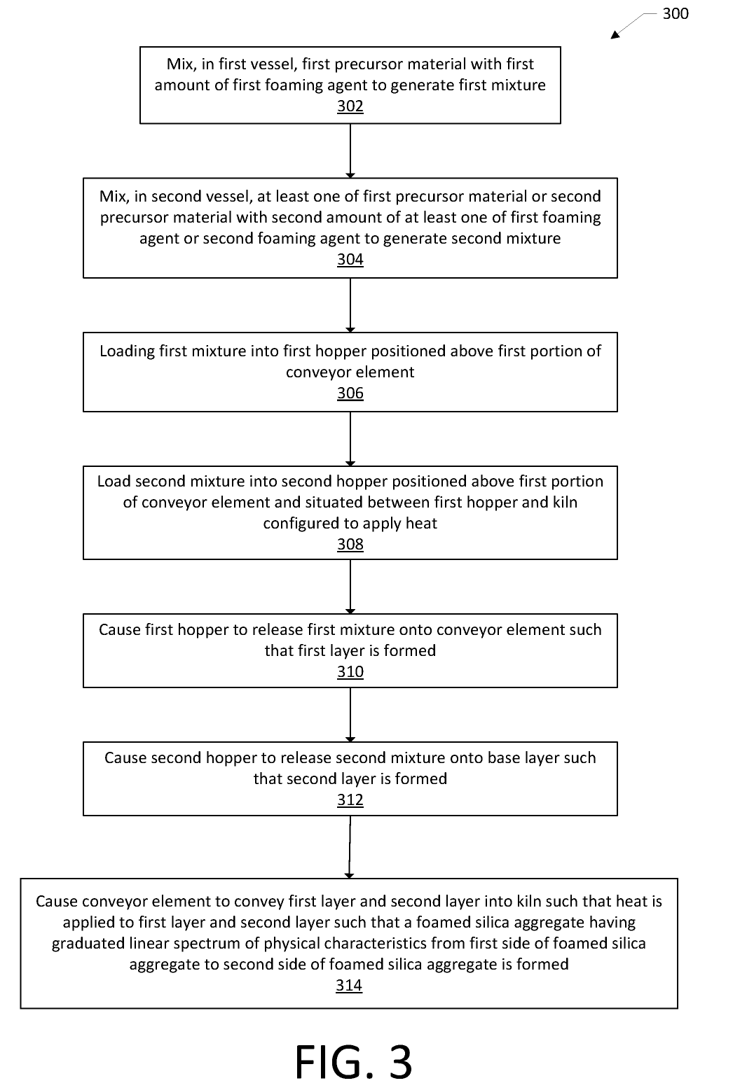

FIGS. 2 and 3 illustrate processes for generation of foamed silicate aggregates having property spectrums. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1 and 4-11, although the processes may be implemented in a wide variety of other environments, architectures and systems.

FIG. 2 is a flowchart illustrating an example process 200 of manufacturing silicate aggregates with property spectrums. The order in which the operations or steps are described is not intended to be construed as a limitation, and any number of the described operations may be combined in any order and/or in parallel to implement process 200.

At block 202, the process 200 may include mixing a first precursor material with a first foaming agent. For example, it may be desirable to generate a foamed silicate aggregate having a graduated linear spectrum of physical and/or chemical properties. In these examples, an operator may identify and/or determine a desired porosity, open-cell and/or closed-cell structure, density, degree of stratification, and/or chemical properties for the produced foamed silicate aggregate to exhibit. It may also be determined that a graduated linear spectrum of one or more of these properties is desired. Given the desired property specifications for a given foamed silicate aggregate, the first precursor material and first foaming agent may be selected such that, when heated by a kiln, a portion of the foamed silicate aggregate may have first properties.

At block 204, the process 200 may include loading a first mixture of the first precursor material and the first foaming agent into a first hopper of a silicate-aggregate generation system. The first hopper may be positioned above a conveyor element of the system. In examples, a derrick may be utilized to move the hopper from a first position associated with loading of the first mixture to a second position above the conveyor element.

At block 206, the process 200 may include mixing a second precursor material with a second foaming agent. In examples, the first precursor material may differ from the second precursor material in one or more physical and/or chemical respects. In other examples, the first precursor material and the second precursor material may be the same or substantially similar. Additionally, the first foaming agent may differ from the second foaming agent in one or more physical and/or chemical respects. In other examples, the first foaming agent and the second foaming agent may be the same or substantially similar. In still other examples, the amount of precursor material and/or foaming agent in each mixture may vary from one mixture to another. Given the desired property specifications for a given foamed silicate aggregate, the second precursor material and second foaming agent may be selected that, when heated by a kiln, will produce a portion of the foamed silicate aggregate having second properties.

At block 208, the process 200 may include loading a second mixture of the second precursor material and the second foaming agent into a second hopper of a silica-aggregate generation system. The second hopper may be positioned above a conveyor element of the system and may be disposed between the first hopper and a kiln of the system. In examples, a derrick may be utilized to move the hopper from a position associated with loading of the second mixture to a position above the conveyor element.

At block 210, the process 200 may include setting, identifying, and/or determining a thickness of the first mixture to be applied to the conveyor element. For example, a shutter located proximate to an opening of the first hopper may be adjusted to allow more or less precursor material to exit the hopper. Additionally, or alternatively, the hopper may include a wheel, roller, and/or drum disposed within the hopper and configured to rotate to promote the flow of precursor material from the hopper to the conveyor element. The thickness of the precursor material applied to the conveyor element may be controlled by increasing or decreasing the amount of precursor material exiting the hopper for a given unit of time.

At block 212, the process 200 may include setting, identifying, and/or determining a thickness of the second mixture to be applied to the conveyor element and/or to the first mixture. The setting, identifying, and/or determining the thickness may be performed in the same or a similar manner as described above with respect to block 210.

At block 214, the process 200 may include releasing and/or causing release of the first mixture from the first hopper. The first mixture may exit an opening of the hopper and may contact the conveyor element as it moves a belt or similar mechanism toward the kiln of the system.

At block 216, the process 200 may include releasing and/or causing release of the second mixture from the second hopper. The second mixture may exit an opening of the hopper and may contact the first mixture as it moves a belt or similar mechanism toward the kiln of the system. In this way, the first mixture may correspond to a first layer of precursor material on the conveyor element and the second mixture may correspond to a second layer of precursor material on the first layer. It should be understood that while this example includes two hoppers, mixtures, and layers, two or more than two hoppers, mixtures, and/or layers may be utilized.

At block 218, the process 200 may optionally include injecting a third material in a grid pattern on the second layer. For example, the system may include one or more injection elements that may be configured to inject a secondary material having one or more differing properties from the layer(s) of precursor materials on top of the layer(s) of precursor materials. In examples, the injection element may apply the secondary material in a grid pattern. When heated by the kiln, the injected secondary material may disperse partially over the top of the precursor materials. In these examples, the side of the foamed silicate aggregate corresponding to the injected seocondary material may have a first surface area that is less than a second surface area corresponding to the layer(s) of precursor materials. In examples, the injected secondary material may include at least one of ceramic, clay, and/or zeolite.

At block 220, the process 200 may include applying heat to the first layer and the second layer of the precursor materials, and the grid of secondary materials, if present. The kiln may be configured to apply heat to the materials as they travel through the kiln. In examples, the amount of heat applied by the kiln to the materials may be adjustable. For example, the temperature inside the kiln may be set to between about 900° Fahrenheit and about 1,600° Fahrenheit. In further examples, the kiln may be configured to apply a heating gradient and/or differing temperatures to the materials as they travel through the kiln. For example, a temperature of the kiln may be adjusted to be the highest about ⅓ of the way through the kiln such that the materials may reach a working point and/or working temperature. Thereafter, the temperature may vary depending on, for example, the speed at which the conveyor element is moving and/or specifications for the silicate aggregate product desired as output from the kiln. In examples, the time between when the materials enter the kiln and when a silicate aggregate product exits the kiln may be between about 40 minutes and about 75 minutes.

At block 222, the process 200 may include fracturing the foamed silicate aggregate. Fracturing of the foamed silicate aggregate may be performed without applying force to the foamed silicate aggregate, such as by natural fracturing while the product cools and/or from the product falling from the conveyor element. In other examples, a compactor may be utilized to apply force to the product, which may cause it to fracture.

At block 224, the process 200 may include collecting the fractured foamed silicate aggregate. For example, the fractured foamed silicate aggregate may be collected in a bin or other storage mechanism. The finalized foamed silicate aggregate may have a roughly two to roughly four-inch diameter and/or largest cross-sectional measurement. The diameter of the finalized product may be dependent on the precursor materials and/or foaming agent used, the heat applied, and/or the cooling time.

FIG. 3 is a flowchart illustrating another example process 300 of manufacturing silicate aggregates with property spectrums. The order in which the operations or steps are described is not intended to be construed as a limitation, and any number of the described operations may be combined in any order and/or in parallel to implement process 300.

At block 302, the process 300 may include mixing, in a first vessel, a first precursor material with a first amount of a first foaming agent to generate a first mixture. For example, it may be desirable to generate a foamed silicate aggregate having a graduated linear spectrum of physical and/or chemical properties. In these examples, an operator may identify and/or determine a desired porosity, open-cell and/or closed-cell structure, density, degree of stratification, and/or chemical properties for the produced foamed silicate aggregate to exhibit. It may also be determined that a graduated linear spectrum of one or more of these properties is desired. Given the desired property specifications for a given foamed silicate aggregate, the first precursor material and first foaming agent may be selected that, when heated by a kiln, will produce a portion of the foamed silicate aggregate having first properties.

At block 304, the process 300 may include mixing, in a second vessel, at least one of the first precursor material or a second precursor material with a second amount of at least one of the first foaming agent or a second foaming agent to generate a second mixture. In examples, the first precursor material may differ from the second precursor material in one or more physical and/or chemical respects. In other examples, the first precursor material and the second precursor material may be the same or substantially similar. Additionally, the first foaming agent may differ from the second foaming agent in one or more physical and/or chemical respects. In other examples, the first foaming agent and the second foaming agent may be the same or substantially similar. In still other examples, the amount of precursor material and/or foaming agent in each mixture may vary from one mixture to another. Given the desired property specifications for a given foamed silicate aggregate, the first precursor material and first foaming agent may be selected that, when heated by a kiln, will produce a portion of the foamed silicate aggregate having first properties.

At block 306, the process 300 may include loading the first mixture into a first hopper positioned above a first portion of a conveyor element. The first hopper may be positioned above a conveyor element of the system. In examples, a derrick may be utilized to move the hopper from a first position associated with loading of the first mixture to a second position above the conveyor element.

At block 308, the process 300 may include loading the second mixture into a second hopper positioned above the first portion of the conveyor element and situated between the first hopper and a kiln configured to apply heat. The second hopper may be positioned above a conveyor element of the system and may be disposed between the first hopper and a kiln of the system. In examples, a derrick may be utilized to move the hopper from a position associated with loading of the first mixture to a position above the conveyor element.

At block 310, the process 300 may include causing the first hopper to release the first mixture onto the conveyor element such that a first layer is formed. The first mixture may exit an opening of the hopper and may contact the conveyor element as it moves a belt or similar mechanism toward the kiln of the system.

At block 312, the process 300 may include causing the second hopper to release the second mixture onto the first layer such that a second layer is formed. The second mixture may exit an opening of the hopper and may contact the first mixture as it moves a belt or similar mechanism toward the kiln of the system. In this way, the first mixture may correspond to a first layer of precursor material on the conveyor element and the second mixture may correspond to a second layer of precursor material on the first layer. It should be understood that while this example includes two hoppers, mixtures, and layers, two or more than two hoppers, mixtures, and/or layers may be utilized.

At block 314, the process 300 may include causing the conveyor element to convey the first layer and the second layer into the kiln such that heat is applied to the first layer and the second layer such that a foamed silicate aggregate having a graduated linear spectrum of physical characteristics from a first side of the foamed silicate aggregate to a second side of the foamed silicate aggregate is formed. The kiln may be configured to apply heat to the precursor material as it travels through the kiln. In examples, the amount of heat applied by the kiln to the precursor materials may be adjustable. For example, the temperature inside the kiln may be set to between about 900° Fahrenheit and about 1,600° Fahrenheit. In further examples, the kiln may be configured to apply a heating gradient and/or differing temperatures to the precursor materials as they travel through the kiln. For example, a temperature of the kiln may be adjusted to be the highest about ⅓ of the way through the kiln such that the precursor materials may reach a working point and/or working temperature. Thereafter, the temperature may vary depending on, for example, the speed at which the conveyor element is moving and/or specifications for the silicate aggregate product desired as output from the kiln. In examples, the time between when the precursor materials enter the kiln and when a silicate aggregate product exits the kiln may be between about 40 minutes and about 75 minutes.

Additionally, or alternatively, the first mixture, when heat is applied by the kiln, may generate an open-cell structure associated with the first layer, and the second mixture, when heating is applied by the kiln, generates a closed-cell structure associated with the second layer. Additionally, or alternatively, the first mixture, when heat is applied by the kiln, may generate a solid structure associated with the first layer, and the second mixture, when heat is applied by the kiln, may generate a porous structure associated with the second layer.

Additionally, or alternatively, the first mixture, when heat is applied by the kiln, may generate a first portion of the foamed silicate aggregate having a first mass, and the second mixture, when heat is applied by the kiln, may generate a second portion of the foamed silicate aggregate having a second mass. In these examples, the second mass may be greater than the first mass. At least one of the first precursor material or the second precursor material may be a material that sinks in a body of water and/or other liquid such that the second portion of the foamed silicate aggregate is oriented downward toward a bottom of the body of water while the first portion is oriented upward toward a surface of the body of water. In other examples, the precursor materials may be materials that float in a body of water and/or other liquid such that the second portion of the foamed silicate aggregate is oriented below a surface of the body of water while the first portion is oriented above the surface of the body of water.

Additionally, or alternatively, the process 300 may include stratifying the first mixture into a first portion of the foamed silicate aggregate and the second mixture into a second portion of the foamed silicate aggregate. In these examples, the first portion may be associated with first physical and/or chemical properties while the second portion may be associated with second physical and/or chemical properties that may differ from the first physical and/or chemical properties.

Additionally, or alternatively, the first mixture, when heat is applied by the kiln, may generate a first portion of the foamed silicate aggregate having first chemical properties, and the second mixture, when heat is applied by the kiln, may generate a second portion of the foamed silicate aggregate having second chemical properties that may differ from the first chemical properties.

Additionally, or alternatively, the process 300 may include injecting, before applying heat by the kiln, a third material onto the second layer in a grid pattern. In these examples, the third material may include at least one of ceramic, clay, and/or zeolite.

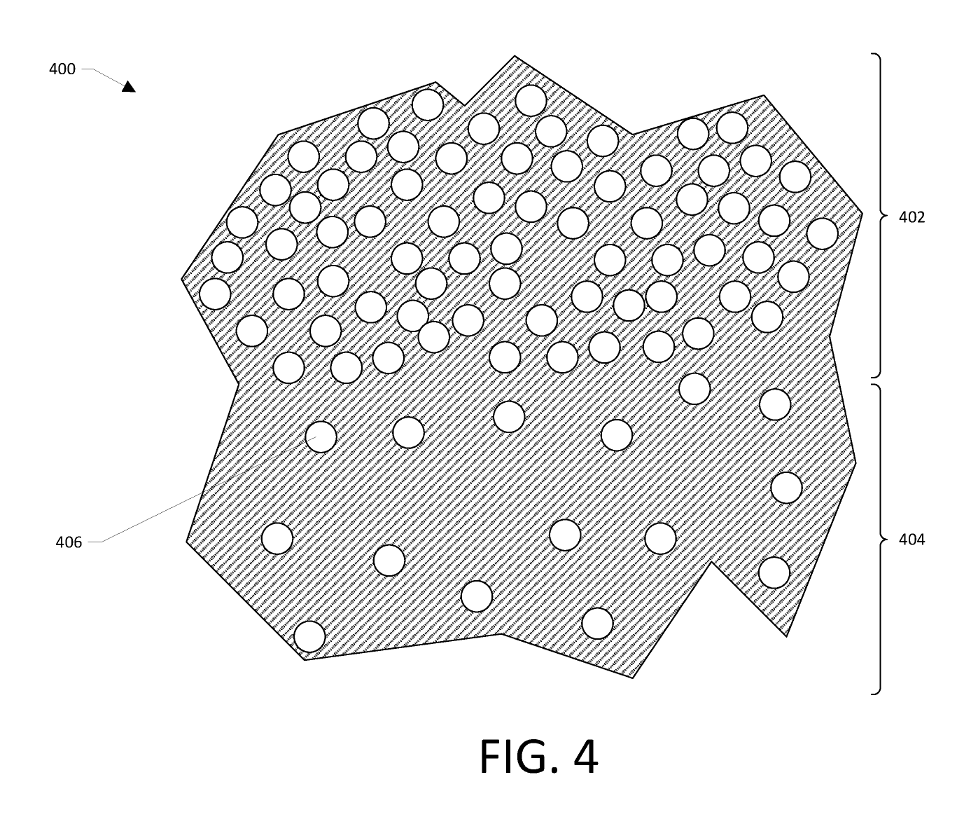

FIG. 4 illustrates a cross-sectional view, taken along a center line, of a foamed silicate aggregate 400 with property spectrums. For example, the foamed silicate aggregate 400 may include a first portion 402 of the foamed silicate aggregate 400 and a second portion 404 of the foamed silicate aggregate 400.

The foamed silicate aggregate 400 may include a graduated linear spectrum of physical characteristics and/or properties. For example, the first portion 402 of the foamed silicate aggregate 400 may include an open-cell structure while the second portion 404 of the foamed silicate aggregate 400 may include a closed-cell structure. As shown in FIG. 4, the first portion 402 includes more cells 406 than the second section 404. Additionally, a portion of the foamed silicate aggregate 400 between and/or including the first portion 402 and the second portion 404 may exhibit a decreasing degree of the open-celled structure from the first portion 402 to the second portion 404 such that the foamed silicate aggregate 400 becomes more closed-celled moving from the first portion 402 to the second portion 404. By so doing, the number of cells 406 may decrease from the first portion 402 to the second portion 404.

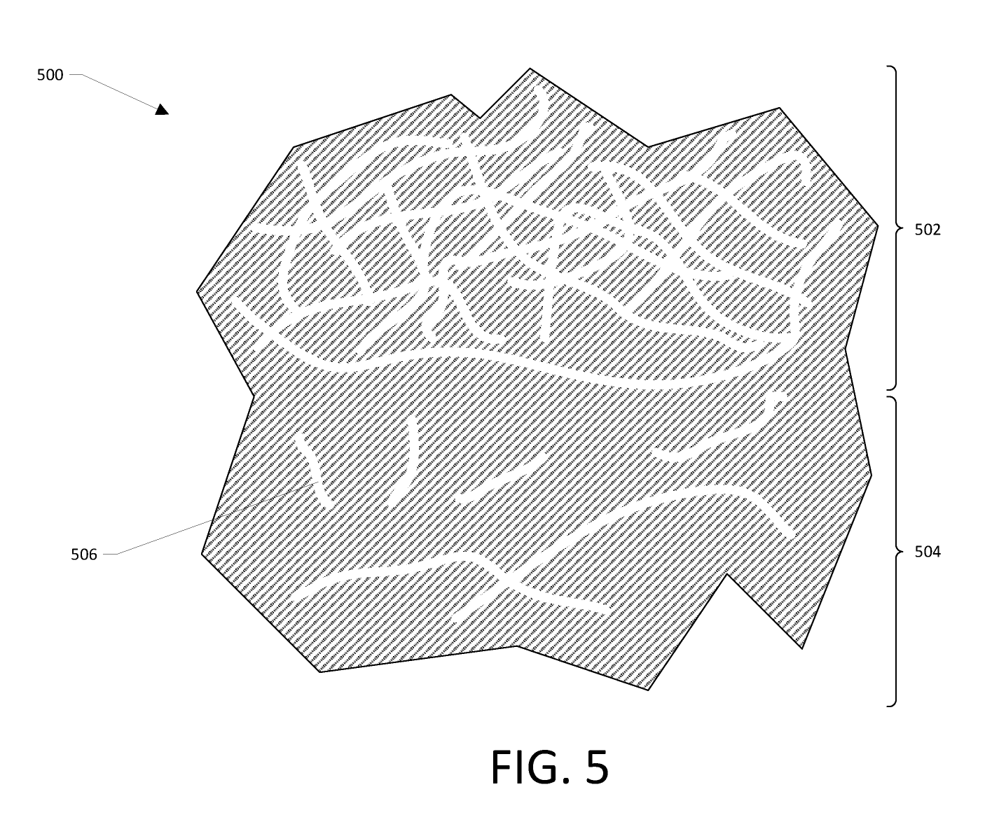

FIG. 5 illustrates a cross-sectional view, taken along a center line, of another foamed silicate aggregate 500 with property spectrums. For example, the foamed silicate aggregate 500 may include a first portion 502 of the foamed silicate aggregate 500 and a second portion 504 of the foamed silicate aggregate 500.

The foamed silicate aggregate 500 may include a graduated linear spectrum of physical characteristics and/or properties. For example, the first portion 502 of the foamed silicate aggregate 500 may include a porous structure while the second portion 504 of the foamed silicate aggregate 500 may include a solid and/or anti-porous structure. As shown in FIG. 5, the first portion 502 includes more channels 506 than the second portion 504. Additionally, a portion of the foamed silicate aggregate 500 between and/or including the first portion 502 and the second portion 504 may exhibit a decreasing degree of the porous structure from the first portion 502 to the second portion 504 such that the foamed silicate aggregate 500 becomes more solid moving from the first portion 502 to the second portion 504. By so doing, the number of channels 506 may decrease from the first portion 502 to the second portion 504.

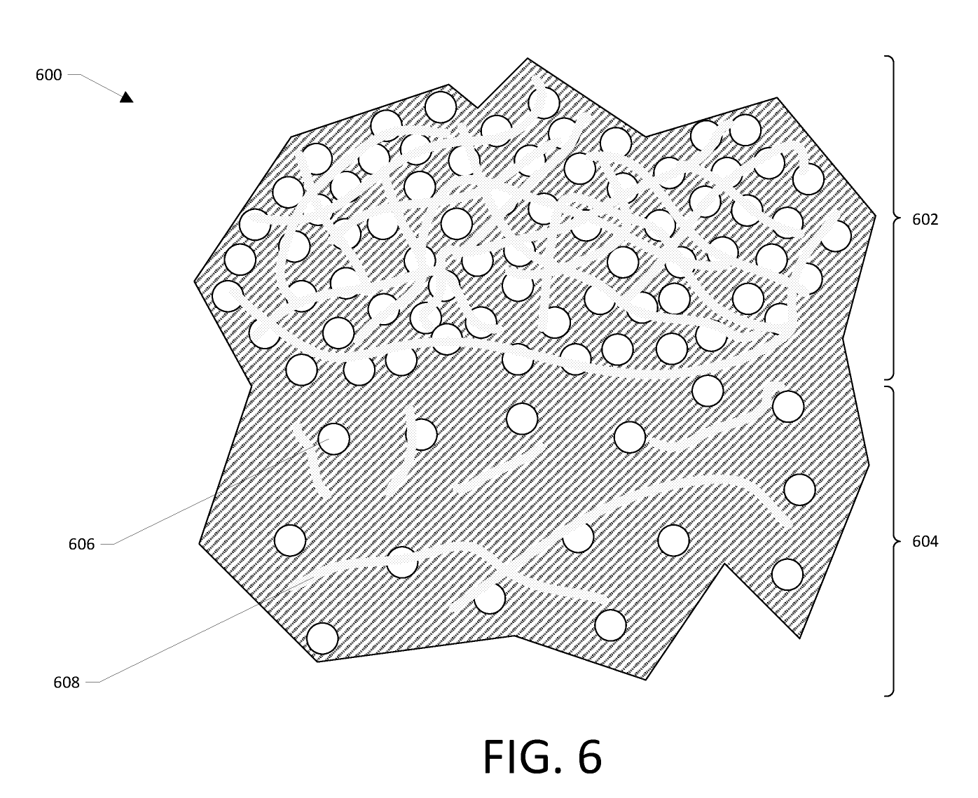

FIG. 6 illustrates a cross-sectional view, taken along a center line, of another foamed silicate aggregate 600 with property spectrums. For example, the foamed silicate aggregate 600 may include a first portion 602 of the foamed silicate aggregate 600 and a second portion 604 of the foamed silicate aggregate 600.

The foamed silicate aggregate 600 may include a graduated linear spectrum of physical characteristics and/or properties. For example, the first portion 602 of the foamed silicate aggregate 600 may include a porous, open-cell structure while the second portion 604 of the foamed silicate aggregate 600 may include a solid, closed-cell structure. As shown in FIG. 6, the first portion 602 includes more cells 606 and channels 608 than the second portion 604. Additionally, a portion of the foamed silicate aggregate 600 between and/or including the first portion 602 and the second portion 604 may exhibit a decreasing degree of the porous and/or open-cell structure from the first portion 602 to the second portion 604 such that the foamed silicate aggregate 600 becomes more solid moving from the first portion 602 to the second portion 604. By so doing, the number of cells 606 and/or channels 608 may decrease from the first portion 602 to the second portion 604.

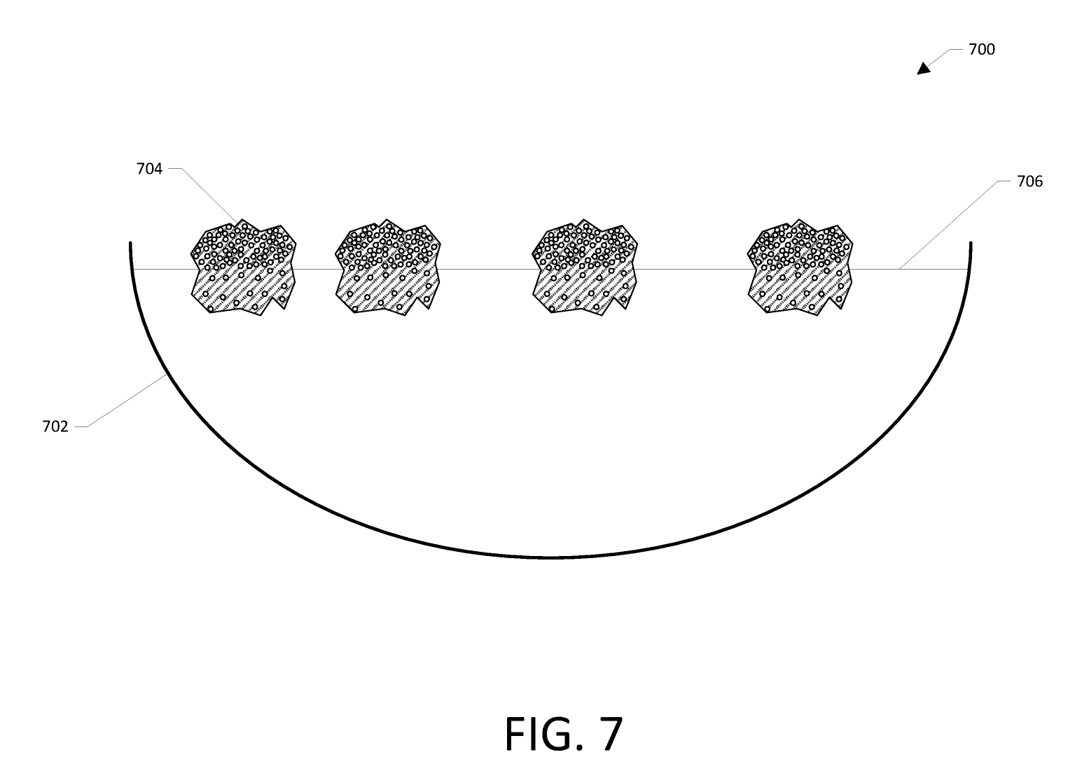

FIG. 7 illustrates a perspective view of an example environment 700 containing a body of water 702, where example foamed silicate aggregates 704 with property spectrums are configured to float on a surface 706 of the body of water 702.

For example, a first side and/or a first portion of the foamed silicate aggregate 704 may have a first mass and/or a first weight, while a second side and/or a second portion of the foamed silicate aggregate 704 may have a second mass and/or a second weight. In these examples, the second mass may be greater than the first mass. As such, the foamed silicate aggregate 704 may be heavier on one side than on another side. In examples, the precursor material used to form at least a portion of the foamed silicate aggregate 704 may be a material that floats in water and/or other liquid. In these examples where the foamed silicate aggregate 704 is constructed of a material that floats in water and where the graduated linear spectrum of physical characteristics includes varying weights of the foamed silicate aggregate 704, the foamed silicate aggregate 704 may be placed into the body of water 702 and a side (here the second side) that is heavier than another side (here the first side) may orient itself downward such that the second side is oriented below the surface 706 of the body of water 702 while the first side is oriented above the surface 706 of the body of water 702. These foamed silicate aggregates 704 may be utilized, for example, in waste remediation efforts.

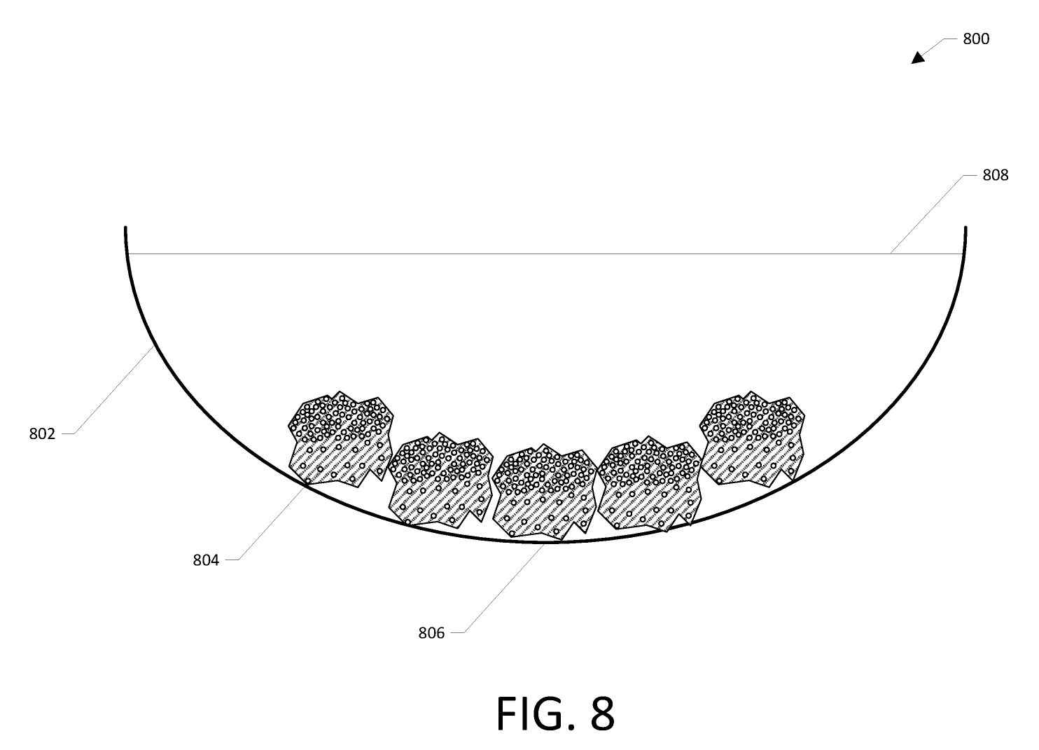

FIG. 8 illustrates a perspective view of an example environment containing a body of water 802, where example foamed silicate aggregates 804 with property spectrums are configured to sink to a bottom portion 806 of the body of water 802.

For example, a first side and/or a first portion of the foamed silicate aggregate 804 may have a first mass and/or a first weight, while a second side and/or a second portion of the foamed silicate aggregate 804 may have a second mass and/or a second weight. In these examples, the second mass may be greater than the first mass. As such, the foamed silicate aggregate 804 may be heavier on one side than on another side. In examples, the precursor material used to form at least a portion of the foamed silicate aggregate 804 may be a material that sinks in water and/or other liquid. In these examples where the foamed silicate aggregate 804 is constructed of a material that sinks in water and where the graduated linear spectrum of physical characteristics includes varying weights of the foamed silicate aggregate 804, the foamed silicate aggregate 804 may be placed into the body of water 802 and may sink to the bottom portion 806 of the body of water 802. A side (here the second side) that is heavier than another side (here the first side) may orient itself downward such that the second side is disposed on the bottom portion 806 of the body of water 802 while the first side is oriented toward a surface 808 of the body of water 802. These foamed silicate aggregates 804 may be utilized, for example, in waste remediation efforts.

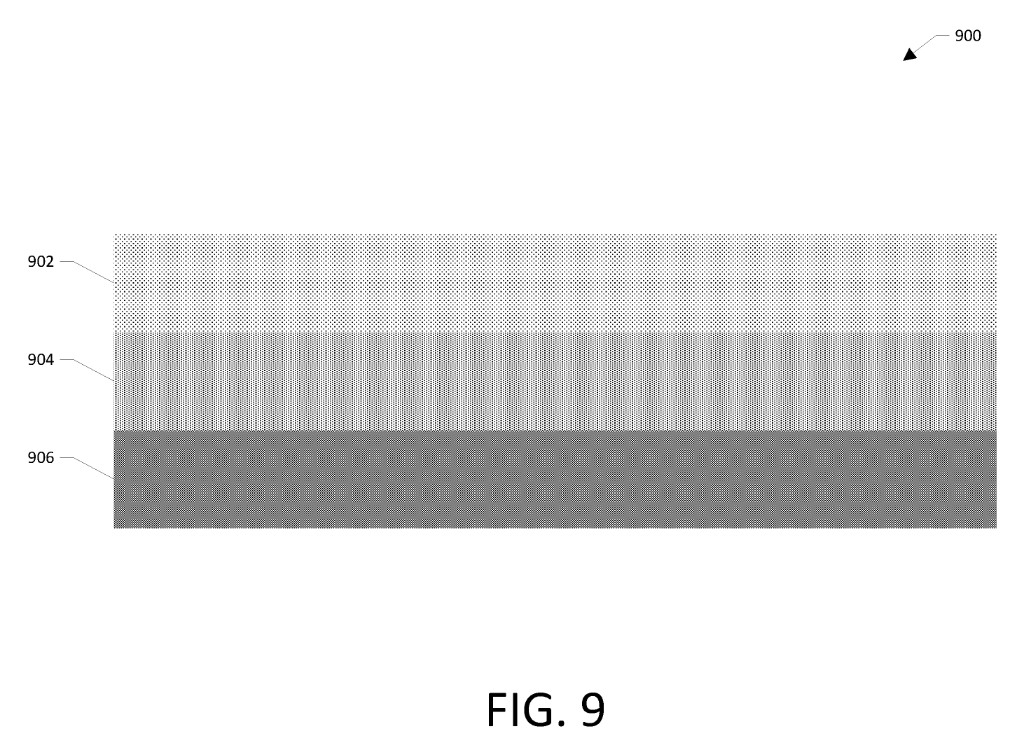

FIG. 9 illustrates a cross-sectional view of an example stratified foamed silicate aggregate 900 with property spectrums. In this example, the foamed silicate aggregate 900 has a first layer 902, a second layer 904, and a third layer 906.

In these examples, some or all of the layers 902-906 may be associated with physical and/or chemical properties that differ from one or more other layers 902-906 of the foamed silicate aggregate 900. For example, the layers 902-906 may be constructed of different precursor materials with different chemical compositions, the layers 902-906 may have differing porosities, the layers 902-906 may have differing densities, some of the layers 902-906 may be open-celled while other layers 902-906 may be closed-celled and/or the degree of open-celled structure may differ as between layers 902-906, and/or the masses and/or weights of the layers 902-906 may differ. It should be understood that while the foamed silicate aggregates 900 may be described as stratified, the layers 902-906 may not be completely separate in some examples. Instead, the junction and/or interface between layers 902-906 may include an area where the layers 902-906 are bonded, at least partially, together. These junctions and/or interfaces may include characteristics that are the same as or differ from one or more of the layers 902-906 themselves.

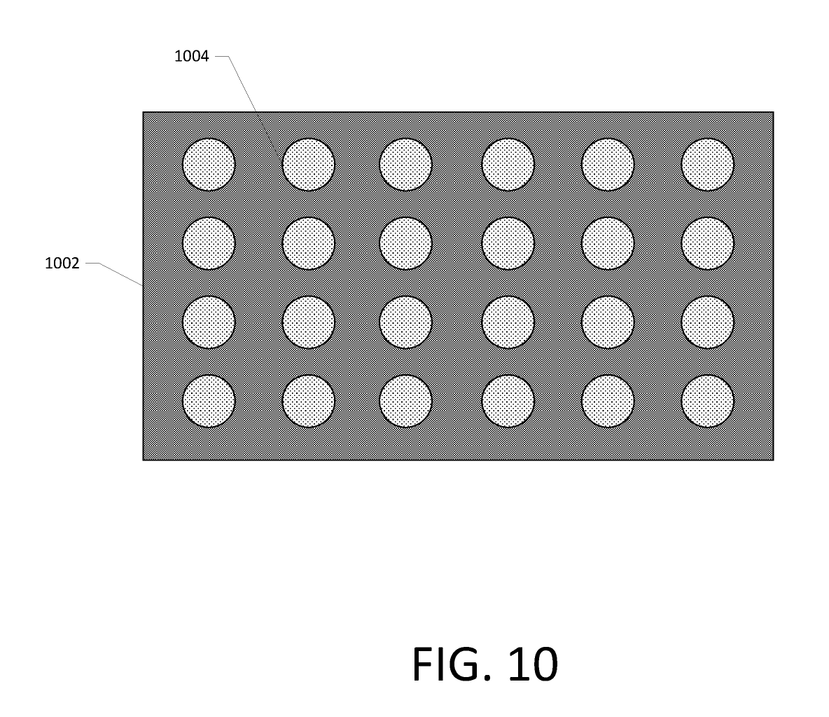

FIG. 10 illustrates a top view of example precursor material 1002 to which a grid of secondary material 1004 has been applied.

For example, one or more layers of precursor materials 1002 may be applied to a conveyor element and an injection element may inject a secondary material 1004 having one or more differing properties from the layer(s) of precursor materials 1002 on top of the layer(s) of precursor materials 1002. In examples, the injection element may apply the secondary material 1004 in a grid pattern. When heated by the kiln, the secondary material 1004 may disperse partially over the top of the precursor materials 1002. In these examples, the side of the foamed silicate aggregate corresponding to the secondary material 1004 may have a first surface area that is less than a second surface area corresponding to the layer(s) of precursor materials 1002. In examples, the secondary material 1004 may include at least one of ceramic, clay, and/or zeolite.

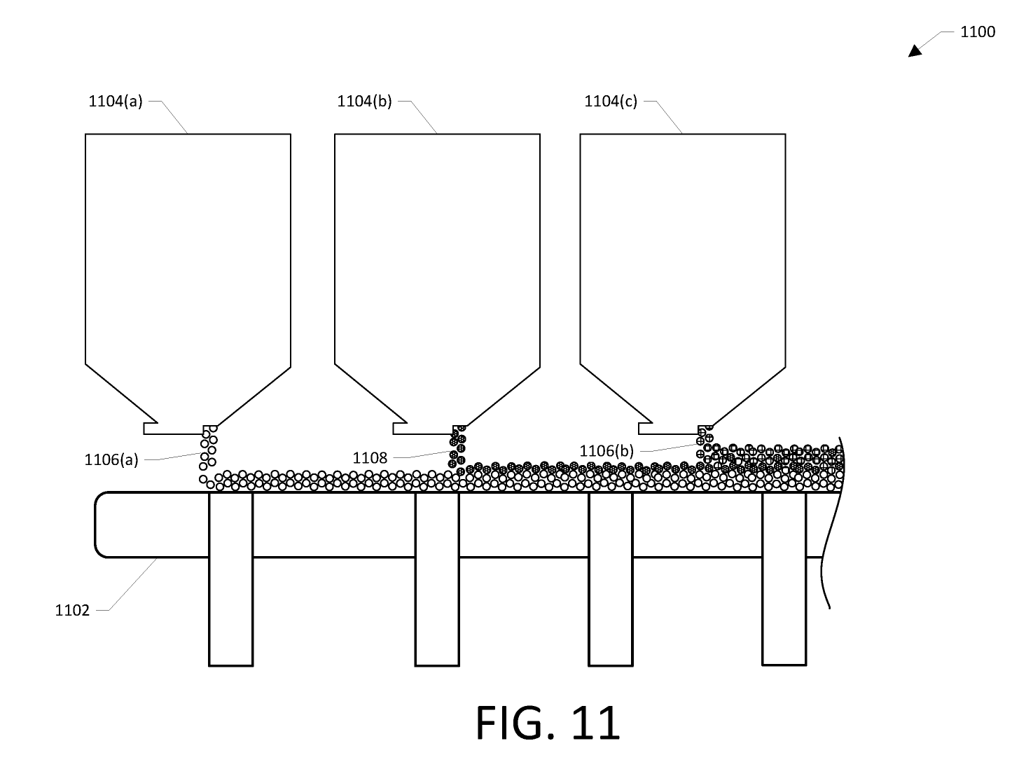

FIG. 11 illustrates a schematic view of an example system 1100 for generating foamed silicate aggregates having property spectrums and the application of precursor materials to a conveyor element of the system 1100. The system 1100 is shown having three hoppers 1104(a)-(c), with the first hopper 1104(a) outputting a first precursor material 1106(a) and the third hopper 1104(c) outputting a second precursor material 1106(b). The second hopper 1104(b) may be outputting one or more pellets and/or beads 1108 that differ from the first precursor material 1104(a) and the second precursor material 1104(b). The beads 1108 may be comprised of at least one of ceramic, clay, or zeolite. In this example, the beads 1108 may be suspended in between the first layer of materials and the second layer of materials, and/or the beads 1108 may be dispersed, at least partially, within the first layer and/or the second layer.

The system 1100 may further include, for example, a conveyor element 1102, the one or more hoppers 1104(a)-(c), and a kiln (not depicted). In examples, the conveyor element 1102 may include the same or similar components and may operate in the same or a similar manner as the conveyor element 102 described with respect to FIG. 1. Additionally, the hoppers 1104(a)-(c) may include the same or similar components and may operate in the same or a similar manner as the hoppers 104(a)-(c) described with respect to FIG. 1. Additionally, the kiln may include the same or similar components and may operate in the same or a similar manner as the kiln 106 described with respect to FIG. 1.

The hoppers 1104(a)-(c) may be filled with precursor material 1106(a)-(b) and/o beads 1108 as described above. The volume and/or amount of precursor material 1106(a)-(b) and/or beads 1108 may be controllably released from the hoppers 1104(a)-(b) to control the number of layers of material entering the kiln and/or the thickness of a given layer of the material. In the example shown in FIG. 11, the thickness of the two layers of precursor materials 1106(a)-(b) is approximately the same such that, as the precursor materials 606(a)-(b) enter the kiln, a base layer from the first hopper 604(a) and a top layer from the third hopper 604(b) is provided, with the beads 1108 suspended between the two layers. In this example, a produced silicate aggregate may include a two-layer product, with each layer having differing properties from the other layers, such as open versus closed cell, porosity, density, and/or chemical properties, and the beads 1108 may be suspended in between and/or within the two layers.

While various examples and embodiments are described individually herein, the examples and embodiments may be combined, rearranged and modified to arrive at other variations within the scope of this disclosure.

Although embodiments have been described in language specific to structural features and/or methodological acts, it is to be understood that the disclosure is not necessarily limited to the specific features or acts described. Rather, the specific features and acts are disclosed herein as illustrative forms of implementing the claimed subject matter. Each claim of this document constitutes a separate embodiment, and embodiments that combine different claims and/or different embodiments are within the scope of the disclosure and will be apparent to those of ordinary skill in the art after reviewing this disclosure.

What is claimed is:

1. An article of manufacture, comprising:
a foamed silicate aggregate having a graduated linear spectrum of physical characteristics from a first side of the foamed silicate aggregate to a second side of the foamed silicate aggregate, the first side opposite the second side.

2. The article of manufacture of claim 1, wherein the graduated linear spectrum of physical characteristics includes:
an open-cell structure associated with the first side; and
a closed-cell structure associated with the second side; and
wherein a portion of the foamed silicate aggregate between the first side and the second side exhibits a decreasing degree of the open-celled structure from the first side to the second side.

3. The article of manufacture of claim 1, wherein the graduated linear spectrum of physical characteristics includes:
a solid structure associated with the first side; and
a porous structure associated with the second side; and
wherein a portion of the foamed silicate aggregate between the first side and the second side exhibits an increasing degree of porosity from the first side to the second side.

4. The article of manufacture of claim 1, wherein the graduated linear spectrum of physical characteristics includes:
a first portion of the foamed silicate aggregate having a first mass, the first portion including the first side of the foamed silicate aggregate; and
a second portion of the foamed silicate aggregate having a second mass, the second portion including the second side of the foamed silicate aggregate, the second mass being greater than the first mass; and
wherein the foamed silicate aggregate is constructed of a material that sinks in a body of water.

5. An article of manufacture, comprising:
a foamed silicate material having a linear spectrum of characteristics from a first side of the foamed silicate material to a second side of the foamed silicate material, the first side opposite the second side.

6. The article of manufacture of claim 5, wherein the linear spectrum of characteristics includes:
an open-cell structure associated with the first side; and
a closed-cell structure associated with the second side; and
wherein a portion of the foamed silicate material between the first side and the second side exhibits an increasing degree of the open-celled structure from the second side to the first side.

7. The article of manufacture of claim 5, wherein the linear spectrum of characteristics includes:
a solid structure associated with the first side; and
a porous structure associated with the second side; and
wherein a portion of the foamed silicate material between the first side and the second side exhibits a decreasing degree of porosity from the second side to the first side.

8. The article of manufacture of claim 5, wherein the linear spectrum of characteristics includes:
a first portion of the foamed silicate material having a first mass, the first portion including the first side of the foamed silicate material; and
a second portion of the foamed silicate material having a second mass, the second portion including the second side of the foamed silicate material, the second mass being greater than the first mass; and
wherein the foamed silicate material is constructed of a material that sinks in a body of water such that the second portion is oriented downward toward the bottom of a body of water while the first portion is oriented upward toward a surface of the body of water.

9. The article of manufacture of claim 5, wherein the linear spectrum of characteristics includes:
a first portion of the foamed silicate material having a first mass, the first portion including the first side of the foamed silicate material; and
a second portion of the foamed silicate material having a second mass, the second portion including the second side of the foamed silicate material, the second mass being greater than the first mass; and
wherein the foamed silicate material is constructed such that the foamed silicate material floats in a body of water such that the second portion is oriented below a surface of the body of water while the first portion is oriented above the surface of the body of water.

10. The article of manufacture of claim 5, wherein the foamed silicate material is stratified into a first layer and a second layer, the first layer including the first side, the second layer including the second side, the first layer associated with first physical properties, the second layer associated with second physical properties that differ from the first physical properties.

11. The article of manufacture of claim 5, wherein the linear spectrum of characteristics includes:
first chemical properties associated with the first side; and
second chemical properties associated with the second side;
wherein a portion of the foamed silicate material between the first side and the second side exhibits third chemical properties representing a decreasing degree of the first chemical properties and an increasing degree of the second chemical properties from the first side to the second side.

12. The article of manufacture of claim 5, wherein:
the first side is associated with a first surface area;
the second side is associated with a second surface area that is larger than the first surface area;
a first portion of the foamed silicate material that includes the first side is constructed of at least one of ceramic, clay, or zeolite; and
a second portion of the foamed silicate material that includes the second side is constructed of a glass-grade silica.

13. A method comprising:
mixing, in a first vessel, a first precursor material with a first amount of a first foaming agent to generate a first mixture;
mixing, in a second vessel, at least one of the first precursor material or a second precursor material with a second amount of at least one of the first foaming agent or a second foaming agent to generate a second mixture;
loading the first mixture into a first hopper positioned above a portion of a conveyor element;
loading the second mixture into a second hopper positioned above the portion of the conveyor element and situated between the first hopper and a kiln configured to apply heat;
causing the first hopper to release the first mixture onto the conveyor element such that a first layer is formed;
causing the second hopper to release the second mixture onto the first layer such that a second layer is formed; and
causing the conveyor element to convey the first layer and the second layer into the kiln such that heat is applied to the first layer and the second layer and a foamed silicate aggregate is formed, the foamed silicate aggregate having a graduated linear spectrum of physical characteristics from a first side of the foamed silicate aggregate to a second side of the foamed silicate aggregate.

14. The method of claim 13, wherein:
the first mixture, when heat is applied by the kiln, generates an open-cell structure associated with the first layer; and
the second mixture, when heat is applied by the kiln, generates a closed-cell structure associated with the second layer.

15. The method of claim 13, wherein:
the first mixture, when heat is applied by the kiln, generates a solid structure associated with the first layer; and
the second mixture, when heat is applied by the kiln, generates a porous structure associated with the second layer.

16. The method of claim 13, wherein:
the first mixture, when heat is applied by the kiln, generates a first portion of the foamed silicate aggregate having a first mass; and
the second mixture, when heat is applied by the kiln, generates a second portion of the foamed silicate aggregate having a second mass, the second mass being greater than the first mass; and
wherein at least one of the first precursor material or the second precursor material sinks in a body of water such that the second portion is oriented downward toward a bottom of the body of water while the first portion is oriented upward toward a surface of the body of water.

17. The method of claim 13, wherein:
the first mixture, when heat is applied by the kiln, generates a first portion of the foamed silicate aggregate having a first mass; and
the second mixture, when heat is applied by the kiln, generates a second portion of the foamed silicate aggregate having a second mass, the second mass being greater than the first mass; and
wherein at least one of the first precursor material or the second precursor material floats in a body of water such that the second portion is oriented below a surface of the body of water while the first portion is oriented above the surface of the body of water.

18. The method of claim 13, further comprising stratifying the first mixture into a first portion of the foamed silicate aggregate and the second mixture into a second portion of the foamed silicate aggregate, the first portion associated with first physical properties, the second portion associated with second physical properties that differ from the first physical properties.

19. The method of claim 13, wherein:
the first mixture, when heat is applied by the kiln, generates a first portion of the foamed silicate aggregate having first chemical properties; and
the second mixture, when heat is applied by the kiln, generates a second portion of the foamed silicate aggregate having second chemical properties that differ from the first chemical properties.

20. The method of claim 13, further comprising injecting, before applying heat by the kiln, a third material onto the second layer in a grid pattern, the third material comprising at least one of ceramic, clay, or zeolite.
